(19) United States
(12) Patent Application Publication
(10) Pub. No.: US 2012/0096983 A1
(43) Pub. Date: Apr. 26, 2012

(54) FLYWHEEL STRUCTURES

(75) Inventors: John Michael Pinneo, Portola Valley, CA (US); Jonathan Forrest Garber, Hillsborough, CA (US)

(73) Assignee: SPINLECTRIX INC., Hillsborough, CA (US)

(21) Appl. No.: 13/280,175

(22) Filed: Oct. 24, 2011

Related U.S. Application Data
(60) Provisional application No. 61/406,099, filed on Oct. 22, 2010.
(60) Provisional application No. 61/406,103, filed on Oct. 22, 2010.
(60) Provisional application No. 61/406,102, filed on Oct. 22, 2010.
(60) Provisional application No. 61/406,105, filed on Oct. 22, 2010.
(60) Provisional application No. 61/406,104, filed on Oct. 22, 2010.
(60) Provisional application No. 61/406,107, filed on Oct. 22, 2010.

(51) Int. Cl. F16F 15/305

(52) U.S. Cl. 74/572.12; 74/572.11

(57) ABSTRACT

An improved flywheel including an improved connection between an rotating interior component and an peripheral component. The connection includes a plurality of interfaces which connect the interior component and the peripheral component have radial compliance so as to deform when tensile forces resulting from the rotation of the interior component are transferred to the plurality of interfaces without transferring the tensile forces to the peripheral component.

### CROSS-REFERENCE TO RELATED APPLICATIONS

This application claims priority to U.S. Provisional Application 61/406,103 filed Oct. 22, 2010, entitled “Methods for Stabilization of Flywheels,” U.S. Provisional Application 61/406,102 filed Oct. 22, 2010, entitled “Method of Stabilization of Rotating Machinery,” U.S. Provisional Application 61/406,105 filed Oct. 22, 2010, entitled “Permanent Magnets for Flywheels,” U.S. Provisional Application 61/406,099 filed Oct. 22, 2010, entitled “Flywheel Structures,” U.S. Provisional Application 61/406,104 filed Oct. 22, 2010, entitled “Kinetic Energy Storage Rotor Design,” and U.S. Provisional Application 61/406,107 filed Oct. 22, 2010, entitled “Concrete Vacuum Enclosures for Energy Storage Flywheels.” Each of these references are incorporated herein by reference in their entirety.

### BACKGROUND OF THE INVENTION

1. The Field of the Invention

The present invention relates to flywheel structures. More particularly, the present invention relates to improved systems and methods for coupling the components of flywheels in order to mitigate common failure in the connections.

2. The Relevant Technology

Flywheels contain a rotating body that is used as a means of storing kinetic energy. As it stores kinetic energy the rotating body rotates at high speeds, causing the rotating body to be subject to centrifugal forces. In many cases, these forces limit the upper rotation rate that can be achieved by a flywheel because they fracture or otherwise damage components of the flywheel.

In particular, when the rotating body within a flywheel is constructed such that it consists of a central hub connected by means of radial spokes to a peripheral body with the spokes firmly attached at each end, centrifugal forces impose radial tensile stresses on the spokes. Such tensile stresses vary with the particulars of materials used for the connection means and their construction, but commonly peak in the range of 30% to 45% radially outward from the component's attachment to the central mass. A typical radial stress profile for such means of connection is shown in FIG. 5(b) of Ha, et al., Optimal Design of a Hybrid Composite Flywheel with a Permanent Magnet Rotor, Journal of Composite Materials, 33: pp. 1544-1575, (1999).

As the flywheel rotation rate increases, a level of tensile stress will be reached such that one or more spokes breaks as its ultimate tensile strength is exceeded by the imposed stress. This is a major limitation on the rotation speed of flywheels, and undesirably limits their utility in many applications.

A variety of means to circumvent this limitation are seen in the prior art. One such means is the use of concentric shells of materials held in compressive pre-stress conditions as in U.S. Pat. No. 5,285,699, in particular FIGS. 6B and 7. This and other such means of applying compressive pre-stress to rotating components mitigate the formation of radial stresses of destructive magnitude at the cost of limiting flywheel rotation speed, and therefore flywheel energy storage capacity, because flywheel rotor materials are thereby brought closer to their failure point due to circumferential, or hoop, stress at a given rotation speed than would otherwise occur. In essence, a portion of the material's maximum operable circumferential stress is sacrificed to mitigate radial stress.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to systems and methods for improving the structure and operation of flywheels.

A first aspect of the invention comprising a flywheel which includes an interior component which rotates in substantially a fixed phase with a peripheral component which rotates, a plurality of mechanical connection components which connect the interior component to the peripheral component and which are fixed to the peripheral component, and a plurality of interfaces which connect the interior component to the plurality of mechanical connection components, the plurality of interfaces having radial compliance so as to deform when tensile forces resulting from the rotation of the interior component are transferred to the plurality of interfaces without transferring the tensile forces to the plurality of mechanical connection components.

A second aspect of the invention is a flywheel comprising a peripheral cylinder having a hollow interior, an interior cylinder housed within the hollow interior of the peripheral cylinder and which rotates in response to a driving force received from a motor, a plurality of mechanical connection components which connect the interior cylinder to the peripheral component so as to transfer the rotational force of the interior cylinder to the peripheral cylinder and which are fixed to an interior circumference of the peripheral cylinder, and a plurality of interfaces which connect the interior cylinder to the plurality of mechanical connection components, the plurality of interfaces having radial compliance so as to deform when tensile forces resulting from the rotation of the interior cylinder are transferred to the plurality of interfaces without transferring the tensile forces to the plurality of mechanical connection components.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a cross section of a flywheel according to one embodiment of the invention which includes a central component and a peripheral component which rotate in a fixed phase; and

FIG. 2 is a cross section illustrating an interface between the central component and a peripheral component.

### DETAILED DESCRIPTION OF THE PREFERRED EMBODIMENTS

Embodiments of the invention relate to an improved structure for a flywheel. More specifically, the embodiments described herein improve the coupling between the components of a flywheel so as to alleviate or reduce the internal stresses of a flywheel.

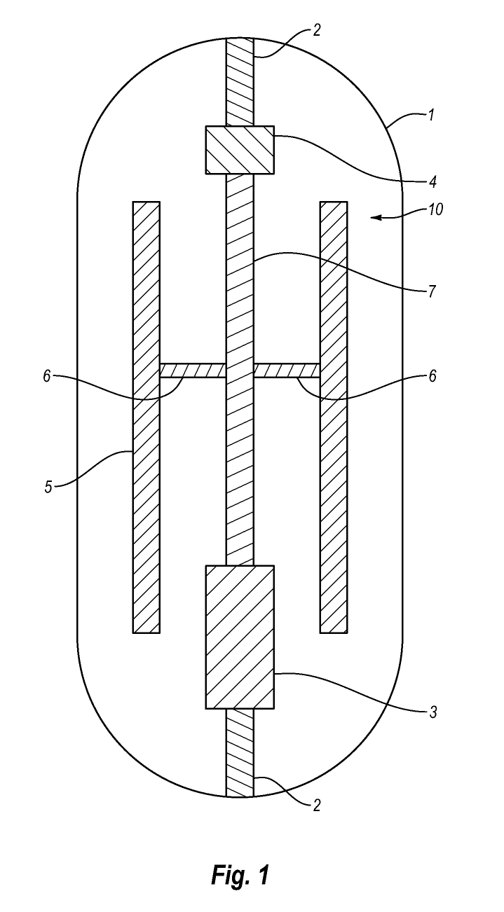

FIG. 1 is a cross sectional view which depicts schematically a flywheel 10 consisting of rotating components, including peripheral component 5 that is connected to central component 7 by mechanical connection means 6, and including supports 2, integrated bearing and motor/generator 3, and bearing 4. The flywheel 10 is shown operating within chamber 1 that is commonly evacuated so as to reduce air pressure to mitigate energy loss due to aerodynamic drag. The chamber 1 is also designed to contain debris in the event of a structural failure of the flywheel 10. Additional components common to the operation of energy storage flywheels are omitted for clarity.

For clarity, only two of at least one of mechanical connection means 6 are depicted, although those of ordinary skill in the art will understand that any number of mechanical connection means 6 may be used in association with the invention.

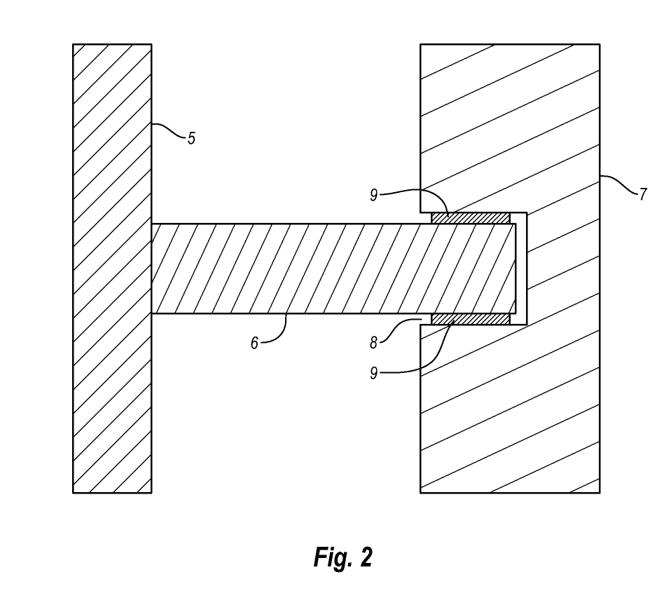

FIG. 2 is a cross-sectional view which more closely illustrates the mechanical connection means 6 of FIG. 1. The mechanical connection means 6 is fixed at its radial outer end to the inner surface of peripheral component 5 and extends within an annular volume 8 forming a cavity within the central component 7. The annular volume 8 is at least partially filled with elastomer interface 9 that is adherently bonded to opposing surfaces of central component 7 and mechanical connection means 6. The annular volume 8 is formed within the central component 7 and accommodates limited radial translation between the connection means 6 and its affixed peripheral component 5.

In a flywheel used for energy storage, with reference to FIGS. 1 and 2, a peripheral rotor component 5 consists of a cylinder comprised of a substantially circumferentially wrapped fiber and/or fiber reinforced material such as Kevlar, carbon fiber, or other suitable fiber known to the art disposed alone or in combination with a surrounding matrix material. In the present embodiment, the rotor comprising the peripheral component 5 consists of a cylinder having a thickness of 1.5 inches and an altitude of 36 inches, having an inner diameter of 24 inches and an outer diameter of 27 inches. The cylinder of the peripheral component 5 is comprised substantially of glass fiber-reinforced epoxy material and its mass is approximately 600 pounds.

A central component 7 is comprised of a suitable material of construction, including but not limited to at least one material drawn from the classes of: metals, ceramics, glasses, and plastics. In this embodiment, central component 7 consists of a cylinder having an outer diameter of four inches, an inner diameter of two inches, and a height of 30 inches. Central component 7 connects with integrated bearing and motor/generator 3 and with bearing 4 and rotates in a substantially fixed phase with peripheral component 5.

Peripheral component 5 and central component 7 are mechanically coupled by at least one radial connection means 6, comprised of a suitable material of construction, including but not limited to at least one material drawn from the classes of: metals, ceramics, glasses, and plastics, that may or may not comprise a single component that traverses the interior of central component 7.

In this embodiment, mechanical connection means 6 consists of three radially disposed cylindrically shaped rods each having a length of approximately 11 inches, and an outer diameter of approximately two inches. In this embodiment, mechanical connection means 6 are fabricated from glass fiber-reinforced epoxy matrix material. Their construction may or may not include dispositions of reinforcing fiber specifically designed to accommodate compressive stress. These three radial connection means 6 are disposed at equal angular intervals of 120 degrees about the circumference of central component 7 and provide support for the weight of peripheral component 5 and provide a means of transmitting torque between central component 7 and peripheral component 5. Mechanical connection means 6 may or may not provide support for all or a portion of the weight of peripheral component 5.

The radial outer ends of mechanical connection means 6 are fixed to the inner surface of peripheral component 5. The radial inner ends of mechanical connection means 6 extend into central component 7 to a distance of approximately one inch when the flywheel is not rotating. Material is removed from central component 7 to accommodate the projection of mechanical connection means 6 into the central component. Specifically, cylindrical cavities having a diameter of 2.25 inches are formed within central component 7 so as to accommodate, and to be concentric with, the projection of mechanical connection means 6 within central component 7. These cavities permit a degree of radial motion of mechanical connection means 6 with respect to central component 7.

In this embodiment, the approximately 0.125 inch thick annulus of free volume surrounding the projection of connecting means 6 within central component 7 is at least partially occupied by a material 9 having a Young's modulus less than that of the materials comprising mechanical connection means 6, and having mechanical properties adequate to resist rupture under forces imposed by flywheel operation, and having the property of adhesion to the adjacent surfaces of central component 7 and mechanical connecting means 6. One such suitable material is Mold Max 25 from Smooth-On, Inc. of Easton, Pa., although one of skill in the art will recognize that other materials may be used in association with embodiments of the invention.

Operation of the flywheel 10 causes centrifugal force to act on central component 7 so as to cause it to expand in at least a radial direction such that the peripheral radial end of the mechanical connecting means 6 translates radially outward with the inner surface of peripheral component 5 along a distance that is dictated by the particulars of flywheel construction, materials, and spin rate. Because of the integral nature of mechanical connection means 6, the entire component shares this radial translation.

In addition, centrifugal force acting on mechanical connection means 6 places it into compressive stress, causing it to foreshorten along its length by an amount determined by the applied force and the Young's modulus of the material comprising the connecting means 6. In this embodiment, the total displacement of the radial inner end of connecting means 6 is approximately 0.02 inches radially outward.

Radial outward translation of connecting means 6 places the elastomer interface 9 under shear force and deforms the elastomer interface 9 accordingly. As well, centrifugal force acts on the elastomer interface 9 and contributes to its deformation. The elastomer interface material having been selected to provide a Young's modulus less than that of mechanical connection means 6 and/or peripheral component 5, the tensile force applied by mechanical connection means 6 by the shear-deformed elastomer interface 9 is resolved with respect to mechanical connection means 6 at the adherent contact region between the elastomer interface 9 and the connection means 6. Therefore, the locus of tensile stress state within mechanical connection means 6 is limited to the proportionately small region in contact with elastomer interface 9, the larger portion of mechanical connection means 6 being held in compression by means of its radial constraint by affixed peripheral component 5.

It will be appreciated by those skilled in the art that a broad range of designs for the interface between connection means 6 and central component 7 will be operable, and variation of the interface over the many operable classes is contemplated by this invention.

It will be appreciated by those skilled in the art that the material comprising the elastomer interface 9 between mechanical connection means 6 and central component 7 affords radial compliance, or the ability to translate radially without the application to mechanical connection means 6 of tensile forces of a destructive magnitude, and that therefore, interface designs having no interface material, but that similarly provide for free radial translation do not depart from the spirit of our invention.

It will be appreciated by those skilled in the art that the particulars of mechanical connection means 6, including but not limited to: materials of composition, shape, number, and/or means of attachment to adjacent components will be determined by the requirements of a specific application, and that such variations do not depart from the spirit of our invention. For example, while the embodiment described above has cylindrically shaped connection means with a circular cross-section, one of skill in the art would understand that the connection means 6 can have a variety of forms without departing from the scope of the following claims.

Thus, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A flywheel comprising:
an interior component which rotates in substantially a fixed phase with a peripheral component which rotates;
a plurality of mechanical connection components which connect the interior component to the peripheral component and which are fixed to the peripheral component; and
a plurality of interfaces which connect the interior component to the plurality of mechanical connection components, the plurality of interfaces having radial compliance so as to deform when tensile forces resulting from the rotation of the interior component are transferred to the plurality of interfaces without transferring the tensile forces to the plurality of mechanical connection components.

2. The flywheel of claim 1, wherein the peripheral component comprises a cylinder comprised of a circumferentially wrapped fiber.

3. The flywheel of claim 2, wherein the cylinder is comprised of a glass fiber-reinforced epoxy material.

4. The flywheel of claim 1, wherein the interior component and the peripheral component are both cylinders and the plurality of mechanical connection components comprise cylindrically shaped rods which radiate from the interior component to support the peripheral component.

5. The flywheel of claim 5, wherein the mechanical connection components are disposed at equal angular intervals about an outer circumference of the central component.

6. The flywheel of claim 1, wherein the mechanical connection components are formed from a glass fiber-reinforced epoxy material.

7. The flywheel of claim 1, wherein the central component has a plurality of cavities formed therein which house one end of the mechanical connection components and the plurality of interfaces.

8. The flywheel of claim 7, wherein the plurality of interfaces are formed of a material having a Young's modulus which is less than that a material of the mechanical connection components.

9. A flywheel comprising:
a peripheral cylinder having a hollow interior;
an interior cylinder housed within the hollow interior of the peripheral cylinder and which rotates in response to a driving force received from a motor;
a plurality of mechanical connection components which connect the interior cylinder to the peripheral component so as to transfer the rotational force of the interior cylinder to the peripheral cylinder and which are fixed to an interior circumference of the peripheral cylinder; and
a plurality of interfaces which connect the interior cylinder to the plurality of mechanical connection components, the plurality of interfaces having radial compliance so as to deform when tensile forces resulting from the rotation of the interior cylinder are transferred to the plurality of interfaces without transferring the tensile forces to the plurality of mechanical connection components.

10. The flywheel of claim 9, wherein the peripheral cylinder further comprises a fiber circumferentially wrapped fiber.

11. The flywheel of claim 10, wherein the fiber is comprised of a glass fiber-reinforced epoxy material.

12. The flywheel of claim 9, wherein the plurality of mechanical connection components comprise cylindrically shaped rods which radiate from an exterior circumference of the interior cylinder to an interior circumference of the peripheral cylinder to support the peripheral cylinder.

13. The flywheel of claim 12, wherein the mechanical connection components are disposed at equal angular intervals about the exterior circumference of the interior cylinder.

14. The flywheel of claim 9, wherein the mechanical connection components are formed from a glass fiber-reinforced epoxy material.

15. The flywheel of claim 9, wherein the interior cylinder has a plurality of cavities formed therein which house one end of the mechanical connection components and the plurality of interfaces.

16. The flywheel of claim 9, wherein the plurality of interfaces are formed of a material having a Young's modulus which is less than that a material of the mechanical connection components.

17. A flywheel comprising:
a peripheral cylinder having a hollow interior;
an interior cylinder housed within the hollow interior of the peripheral cylinder and which rotates in response to a driving force received from a motor;
a plurality of mechanical connection components which connect the interior cylinder to the peripheral component so as to transfer the rotational force of the interior cylinder to the peripheral cylinder and which are fixed to an interior circumference of the peripheral cylinder, the mechanical connection components comprising cylindrically shaped rods which are disposed at equal angular intervals about an exterior circumference of the interior cylinder to an interior circumference of the peripheral cylinder to support the peripheral cylinder; and
a plurality of interfaces which connect the interior cylinder to the plurality of mechanical connection components, the plurality of interfaces having radial compliance so as to deform when tensile forces resulting from the rotation of the interior cylinder are transferred to the plurality of interfaces without transferring the tensile forces to the plurality of mechanical connection components,
wherein the interior cylinder has a plurality of cylindrically shaped cavities formed therein which house one end of the mechanical connection components and the plurality of interfaces.

18. The flywheel of claim 17, wherein the peripheral cylinder further comprises a fiber circumferentially wrapped fiber of a glass fiber-reinforced epoxy material.

19. The flywheel of claim 17, wherein the mechanical connection components are formed from a glass fiber-reinforced epoxy material.

20. The flywheel of claim 17, wherein the plurality of interfaces are formed of a material having a Young's modulus which is less than that a material of the mechanical connection components.
